(19) United States
(12) Patent Application Publication
(10) Pub. No.: US 2016/0159298 A1
(43) Pub. Date: Jun. 9, 2016

(54) DEVICE AND METHOD FOR OPERATING AN ENERGY STORAGE ARRANGEMENT OF A MOTOR VEHICLE

(71) Applicant: ROBERT BOSCH GMBH, Stuttgart (DE)

(72) Inventors: Bernd Eckert, Stuttgart (DE); Petra Kanters, Ludwigsburg (DE)

(21) Appl. No.: 14/888,492

(22) PCT Filed: Mar. 31, 2014
(86) PCT No.: PCT/EP2014/056447

§ 371 Date: Nov. 2, 2015

(30) Foreign Application Priority Data
May 2, 2013 (DE) 10 2013 208 078.6

(51) Int. Cl. B60R 16/033; B60L 11/18; B60L 15/00; B60L 11/02

(52) U.S. Cl. CPC B60R 16/033; B60L 11/02; B60L 11/1816; B60L 15/007

(57) ABSTRACT

The invention relates to a device (100) for operating an energy storage arrangement (2) of a motor vehicle (1), comprising a first charging device (110) with a generator device (111) which can be driven by an internal combustion engine (113) of the motor vehicle (1) via an electrically switchable coupling device (112), said first charging device (110) being designed to charge at least one electric energy store (3) of the energy storage arrangement (2) of the motor vehicle (1); comprising a second charging device (140) which is designed to charge at least one electric energy store (3) of the energy storage arrangement (2) of the motor vehicle (1) from an extravehicular electric energy supply device (150); comprising a detecting device (120) which is designed to detect at least one operating parameter of the motor vehicle (1); and comprising a control device (130) which is coupled to the first charging device (110), the second charging device (140), and the detecting device (120) and which is designed to control the first charging device (110) and the second charging device (140) using the at least one operating parameter.

### BACKGROUND OF THE INVENTION

The invention relates to a device and method for operating an energy storage arrangement of a motor vehicle.

The German patent publication DE 10 2010 014 081 A1 describes an electrical auxiliary energy storage device for an electrical energy storage arrangement in an onboard power system of a motor vehicle. The electrical auxiliary energy storage device supplies additional electrical energy to electrical loads during unfavorable engine load conditions, whereby power losses of the engine are reduced. The auxiliary battery is charged by recuperative systems of the motor vehicle when said vehicle is coasting or by onboard solar cells or via extravehicular charging devices at a stationary power supply system. The exchangeable electrical auxiliary energy storage device is readily accessible and can be easily integrated into the vehicle package in an exchangeable manner.

The German patent publication DE 103 542 96 A1 describes an electrical onboard power system for supplying a high-power load with increased availability requirement, for example an electrohydraulic brake and/or a parking brake. The onboard power system has two energy storage devices, the high-power loads being connected to the second energy storage device. The second energy storage device is connected to the onboard power system via a controllable charging and isolating unit. The two energy storage devices can be individually or collectively connected to the high-power load via the charging and isolating unit. In addition, the second energy storage device can be connected to the onboard power system via the controllable charging and isolating unit.

The German patent publication DE 101 50 379 A1 describes an energy supply system, in particular for onboard power systems of motor vehicles, comprising a plurality of loads which are supplied with energy by means of at least one energy source. According to the invention, the loads are connected to a first energy source via a first supply line and to a second energy source via a second supply line in order to improve the reliability of the relevant loads from breaking down.

The electrical energy consumed onboard of a vehicle operated by an internal combustion engine is generated onboard today exclusively by means of a generator via the internal combustion engine. The generator is driven by the internal combustion engine. The generation of electrical energy takes place approximately with the following levels of efficiency: the generator level of efficiency amounts to 60-70%, the level of efficiency of the belt drive is 96%. This is overlapped by the level of efficiency of the internal combustion engine of the motor vehicle. The average electrical energy consumption of a motor vehicle, dependent on the operating mode, amounts to approximately 600 W. The power requirement of an electric vehicle of the compact class for the drive propulsion amounts approximately to 20 kW over a distance of 100 km. In consideration of the levels of efficiency of generator and belt drive, approximately 1 kW of mechanical drive capacity is required for the generator in vehicles with an internal combustion engine. Thus, approximately 5% of the power of the internal combustion engine is used for providing the electrical energy of the onboard power system.

### SUMMARY OF THE INVENTION

The present invention relates to a device for operating an energy storage arrangement of a motor vehicle and a method for operating an energy storage arrangement.

The gist of the invention is that the generation of current by the onboard generator is replaced by current from the power system for short distances. Thus, the operation of the generator device is no longer required during the short distance operation of the motor vehicle. During long distance drives, the onboard generator device is only switched on upon reaching a defined charging state threshold of the electric energy store and thereby supplies the motor vehicle with electrical energy.

The operation of the motor vehicle is in no way subject to the constraint of a limited driving range. Long distance drives are possible without any problem. An auxiliary charging device recharges the electric energy store when the vehicle is shut down.

When using electrical energy from regenerative sources, the carbon dioxide emissions of the motor vehicle are reduced by approximately 5% for short distance travel. The fuel consumption is reduced in any case in accordance with the proportion of consumed battery current.

The generator device is switched on by the control device if a certain state of charge is undershot or if the motor vehicle is decelerated. The generator device is enhanced with an electrically switchable coupling device which is controlled by a battery management system in the form of the control device.

Provision is made according to one embodiment of the invention for the detecting device to be designed to detect a state of charge of an electric energy store of the energy storage arrangement as the at least one operating parameter. This advantageously allows for an optimal operating strategy of the energy storage arrangement to be provided.

Provision is made according to one embodiment of the invention for the electrically switchable coupling device to be designed as an electromagnetic friction clutch. This advantageously prevents a load torque from occurring, which is caused by a co-rotation of the generator device and decelerates the motor vehicle.

Provision is made according to one embodiment of the invention, for the generator device to be able to be driven by the internal combustion engine of the motor vehicle as an auxiliary unit or via a friction wheel or via a belt. This advantageously allows for the electrical energy to be provided for charging the electric energy store of the energy storage arrangement.

Provision is made according to one embodiment of the invention for the control device to additionally be designed to operate the first and the second charging device of the motor vehicle using the operating parameter data stored in the storage device.

According to one embodiment of the invention, provision is made for the detecting device to be designed to be coupled to a bus system of the motor vehicle.

This advantageously allows for the operating parameters of the motor vehicle to be detected.

The embodiments of and modifications to the invention described above can be combined with each other in any arbitrary manner.

Further possible embodiments, modifications and implementations of the invention also do not explicitly comprise specified combinations of features of the invention that have been previously described or will be subsequently described with regard to the exemplary embodiments.

### BRIEF DESCRIPTION OF THE DRAWINGS

The attached drawings are intended to convey a further understanding of the embodiments of the invention. They illustrate embodiments and are used in combination with the description to explain principles and concepts of the invention.

Other embodiments and many of the stated advantages result in view of the drawings. The elements depicted in the drawings are not necessarily depicted true to scale in relation to one another.

In the drawings:

FIG. 1 shows a schematic depiction of a device for operating an energy storage arrangement of a motor vehicle according to one embodiment of the invention;

FIG. 2 shows a schematic depiction of a device for operating an energy storage arrangement of a motor vehicle according to a further embodiment of the invention; and

FIG. 3 shows a schematic depiction of a flow diagram of a method for operating an energy storage arrangement of a motor vehicle according to a further embodiment of the invention.

### DETAILED DESCRIPTION

In the figures of the drawings, identical reference signs denote identical or functionally identical elements, constituent parts, components or procedural steps, provided that nothing is stated to the contrary.

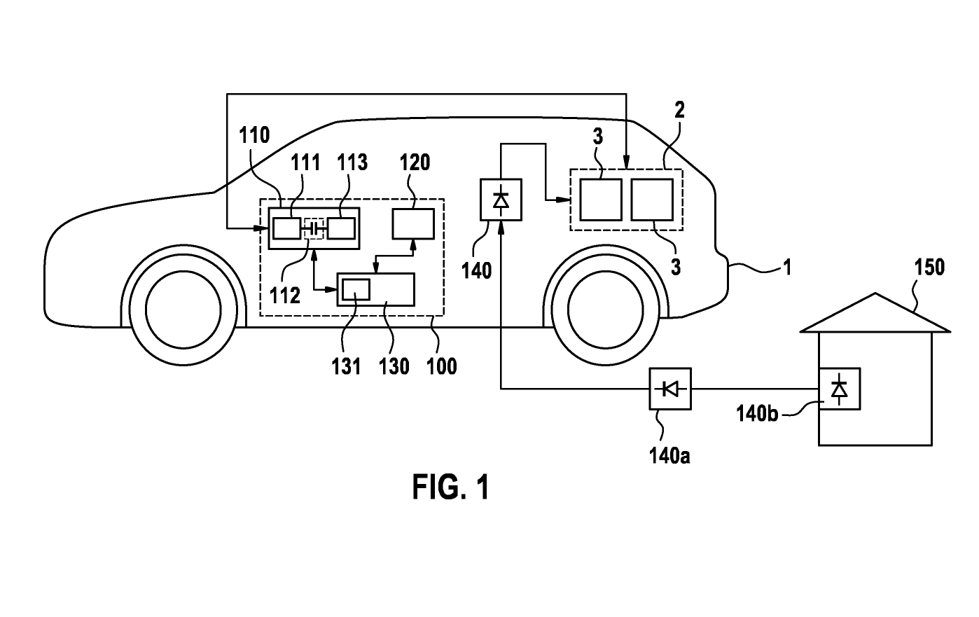

FIG. 1 shows a schematic depiction of a device for operating an energy storage arrangement of a motor vehicle according to one embodiment of the invention.

The device 100 for operating an energy storage arrangement 2 of a motor vehicle 1 comprises a first charging device 110, a second charging device 140, a detecting device 120 and a control device 130.

The first charging device 110 can, for example, comprise a generator device 111 and an electrically switchable coupling device 112, wherein the generator device 111 can be driven by an internal combustion engine 113 of the motor vehicle 1 via the electrically switchable coupling device 112.

As a result, the internal combustion engine 113 can transfer mechanical energy to the generator device 111. The generator device 111 of the device 100 is, for example, designed as an electric generator which converts kinetic energy or mechanical energy into electric energy.

The electric energy generated in this way can then be transmitted by means of a charging circuit of the device 100 to the at least one electric energy store 3 of the energy storage arrangement 2 of the motor vehicle 1 and thus increase the state of charge of the electric energy store 3.

The detecting device 120 can furthermore be designed to detect a state of charge of an electric energy store 3 of the energy storage arrangement 2 as the at least one operating parameter.

The energy storage arrangement 2 of the motor vehicle 1 comprises two electric energy stores 3 in the embodiment depicted in FIG. 1.

In divergence therefrom, the energy storage arrangement 2 can however have any number of electric energy stores 3 and therefore an energy storage arrangement comprising only one energy store is also possible.

The electrically switchable coupling device 112 is, for example, designed as an electromagnetic friction clutch. A load torque generated by the generator device 111 can be advantageously prevented by breaking the connection between the internal combustion engine 113 and the electric generator device 111.

The first charging device 110 can be designed to charge at least one electric energy store 3 of the energy storage arrangement 2 of the motor vehicle 1.

The second charging device 140 is, for example, designed to charge at least one electric energy store 3 of the energy storage arrangement 2 of the motor vehicle 1 from an extravehicular electric energy supply device 150.

The second charging device 140 can comprise an electric converter which is designed to convert frequency, current and/or voltage values of the extravehicular electric energy supply device 150 to corresponding frequency, current and/or voltage values of the at least one electric energy store 3.

The electric converter can be installed as an electrical component in the motor vehicle 1.

The electric converter can furthermore also be installed as an electrical component 140a in a charging connection cable of the motor vehicle 1 or in the extravehicular electric energy supply device 150.

The detecting device 120 is, for example, designed to detect at least one operating parameter of the motor vehicle 1. A state of charge of the at least one electric energy store 3 of the energy storage arrangement 2 can, for example, be detected as the at least one operating parameter.

To this end, the detecting device 120 can be designed to be coupled to a bus system of the motor vehicle 1. In addition, the detecting device 120 can also have a voltage sensor and/or a charge quantity sensor and/or a current measuring device in order to detect the currently prevailing state of charge of the electric energy store 3 of the energy storage arrangement 2. Alternatively, said detecting device 120 can indirectly detect the currently prevailing state of charge of the electric energy store 3 on the basis of a detection of the charge or current quantities that have flowed to and from the electric energy store 3.

The control device 130 can further have a storage device 131, the first charging device 110 of the motor vehicle 1 being operated on the basis of operating parameter data stored in the storage device 131. A state of charge threshold or other parameters can, for example, be used as operating parameter data.

The state of charge threshold is, for example, changed by the control device 130 as a function of further operating parameters, such as outside temperature, air humidity or an engine temperature of the internal combustion engine 113 or an expected point in time of an engine cold start of the internal combustion engine 113.

In addition, the state of charge threshold of the electric energy store 3 can define an electric energy quantity which is to be provided or permanently held available as a safety reserve by the energy storage arrangement 2.

The control device 130 is, for example, coupled to the first charging device 110 and the second charging device 140 and to the detecting device 120 and can be designed to control and operate the first charging device 110 and the second charging device 140 using the at least one operating parameter.

The device 100 can furthermore have an indicator device, which is not depicted and is, for example, designed as a display. The indicator device can be designed to optically signal variable items of information, such as the at least one operating parameter or another state of the first charging device 110 and to be configured in a dashboard of the motor vehicle 1 as a display or instrument panel comprising measurement indicators and operating levers.

The motor vehicle 1 can be designed as a vehicle with an internal combustion engine, said vehicle being driven by at least one internal combustion engine and the energy being drawn from an operating fuel tank in the motor vehicle 1.

The electric energy store 3 of the energy storage arrangement 2 of the motor vehicle 1 can be designed as an electric energy store in the form of a lithium-iron phosphate battery or as a lithium-titanate battery or as a lithium-polymer battery or as a lithium cobalt oxide battery or in the form of a lithium-sulfur battery or in the form of another lithium-ion battery.

In addition, the electric energy store 3 of the energy storage arrangement 2 can also be designed in the form of a lead battery or another multiply rechargeable store for electric energy on an electrochemical basis.

The storage device 131 of the device 100 is, for example, designed as a semiconductor store which is constructed from a semiconductor, wherein microelectronic storage structures are implemented in and on a semiconductor crystal, wherein a state of charge threshold can be stored in the storage device 131.

The control device 130 of the device 100 is, for example, designed in each case as a processing unit or as another kind of electronic data processing unit.

The first charging device 110, the second charging device 140, the detecting device 120 and the control device 130 are designed as electronic circuit components individually or in an integrated manner and can furthermore be coupled to one another by means of a network structure comprising a bus system.

The control device 130 of the device 100 is, for example, designed in each case as a microcontroller, also μcontroller, or as another kind of electronic computer unit which, in addition to the processor, also combines units for peripheral functions on a chip.

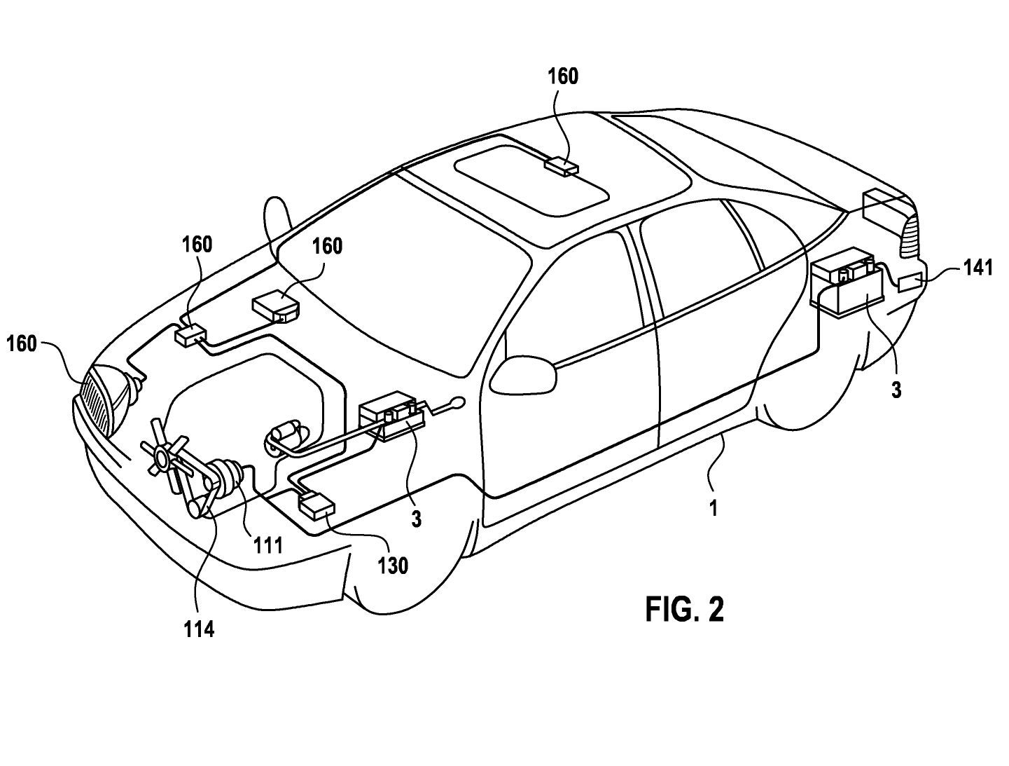

FIG. 2 shows a schematic depiction of a device for operating an energy storage arrangement of a motor vehicle according to one embodiment of the invention.

In divergence from the device 100 depicted in FIG. 1, the second charging device 140 of the device 100 further comprises a charging socket 141 in order to charge the electric energy store 3 of the motor vehicle 1 at a stationary charging station from the extravehicular electric energy supply device 150.

The indicator device can, for example, display the fact that a charging of the electric energy store 3 of the motor vehicle is advantageous in the event of a state of charge corresponding to a certain state of charge threshold having been achieved in the electric energy store 3.

In the embodiment of the device 100 for operating the energy storage arrangement 2 of the motor vehicle 1 depicted in FIG. 2, the charging device 110 is coupled to the internal combustion engine 113 of the motor vehicle 1 via a belt drive 114, such as via a V-ribbed belt or a V-flat belt.

The energy storage arrangement 2 of the motor vehicle 1 comprises two electric energy stores 3 in the embodiment depicted in FIG. 2. A certain state of charge threshold can be associated with each of the two electric energy stores 3.

The motor vehicle 1 comprises a plurality of electric loads 160 of the motor vehicle 1 which are disposed in an electrical onboard power system.

Headlights or an electric drive system for a sunroof of the motor vehicle 1 or an interior fan of the motor vehicle 1 are, for example, provided as the electric loads 160 of said motor vehicle 1.

The additional reference signs depicted in FIG. 2 have already been explained in the description associated with FIG. 1 and are therefore not further described.

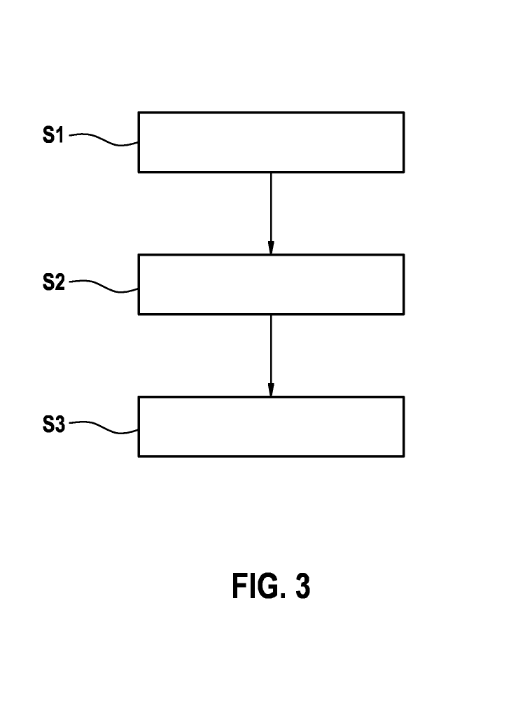

FIG. 3 shows a schematic depiction of a flow diagram of a method for operating an energy storage arrangement of a motor vehicle 1 according to a further embodiment of the invention.

Providing S1 a first charging device 110 and a second charging device 140 for charging an electric energy store 3 of the energy storage arrangement 2 of the motor vehicle 1 constitutes a first procedural step.

Detecting S2 at least one operating parameter of the motor vehicle 1 by means of a detecting device 120 constitutes a second procedural step.

Operating S3 the first charging device 110 and the second charging device 140 of the motor vehicle 1 using the at least one operating parameter which was determined by means of a control device 130 constitutes a third procedural step.

In addition, a state of charge of the electric energy store 3 of the energy storage arrangement 2 can be acquired as the at least one operating parameter in a further procedural step; and the first charging device 110 and the second charging device 140 of the motor vehicle 1 are actuated and operated using the state of charge thresholds stored in the storage device 131.

The first charging device 110 is, for example, driven via the electrically switchable coupling device 112 of the internal combustion engine 113 when the state of charge threshold is not reached in order to again raise the state of charge of the electric energy store 3 of the energy storage arrangement 2.

In addition, the second charging device 140 can fully charge the at least one electric energy store 3 via an extravehicular electric energy supply device 150.

In so doing, the at least one electric energy store 3 of a motor vehicle 1 that has been shut down can be charged, when stationary, via the extravehicular electric energy supply device 150; and an electrical converter can be installed in the motor vehicle 1 or in the extravehicular electric energy supply device 150.

The second charging device 140 can also be designed as a portable device and carried in a trunk of the motor vehicle or be designed in a stationary manner in the extravehicular electric energy supply device 150.

The procedural steps of the method can thereby be iteratively or recursively repeated in any order.

The charging strategy and charging control provided by the method can furthermore prevent the electric energy store 3 of the energy storage arrangement 2 from being overcharged and can maintain a state of charge of the electric energy store 3 of the energy storage arrangement 2 as permanently as possible for an efficient and fuel saving operation of the motor vehicle 1.

The method for operating an energy storage arrangement 2 of a motor vehicle 1 can be carried out by the device 100.

Although the present invention has been described above using preferred exemplary embodiments, said invention is not limited to these exemplary embodiments but can be modified in a variety of ways. The invention can particularly be changed or modified in various ways without deviating from the gist of the invention.

1. A device for operating an energy storage arrangement of a motor vehicle comprising:
a first charging device with a generator device which can be driven by an internal combustion engine of the motor vehicle via an electrically switchable coupling device, said first charging device being designed to charge at least one electric energy store of the energy storage arrangement of the motor vehicle;
a second charging device which is designed to charge at least one electric energy store of the energy storage arrangement of the motor vehicle from an extravehicular electric energy supply device;
a detecting device which is designed to detect at least one operating parameter of the motor vehicle; and
a control device which is coupled to the first charging device, the second charging device and the detecting device and which is designed to control the first charging device and the second charging device using the at least one operating parameter.

2. The device according to claim 1, characterized in that the detecting device is designed to detect a state of charge of an electric energy store of the energy storage arrangement as the at least one operating parameter.

3. The device according to claim 1, characterized in that the electrically switchable coupling device is designed as an electromagnetic friction clutch.

4. The device according to claim 1, characterized in that the generator device of the internal combustion engine of the motor vehicle can be driven as an auxiliary unit or via a friction wheel or a belt.

5. The device according to claim 1, characterized in that the control device is further designed to operate the first charging device and the second charging device of the motor vehicle using operating parameter data stored in the storage device.

6. The device according to claim 1, characterized in that the detecting device is designed to be coupled to a bus system of the motor vehicle.

7. Device according to claim 1, characterized in that the second charging device has an electric converter which is designed to convert at least one from the group consisting of frequency, current and voltage values of the extravehicular electric energy supply device to corresponding frequency, current and/or voltage values of the at least one electric energy store.

8. The device according to claim 7, characterized in that the electric converter is installed as an electrical component in the motor vehicle.

9. The device according to claim 7, characterized in that the electric converter is installed as an electrical component in a charging connection cable of the motor vehicle.

10. The device according to claim 7, characterized in that the electric converter is installed as an electrical component in the extravehicular electric energy supply device.

11. A method for operating an energy storage arrangement of a motor vehicle, comprising the following steps:
providing a first charging device and a second charging device for charging an electric energy store of the energy storage arrangement of the motor vehicle;
detecting at least one operating parameter of the motor vehicle by a detecting device; and
operating the charging device and the second charging device of the motor vehicle using the at least one operating parameter determined by means of a control device.

12. The method according to claim 11, characterized in that a state of charge of an electric energy store of the energy storage arrangement is acquired as the at least one operating parameter.

13. The method according to claim 11, characterized in that the electrically switchable coupling device is designed as an electromagnetic friction clutch.

14. The method according to claim 11, characterized in that a generator device of the internal combustion engine of the motor vehicle is driven as an auxiliary unit or via a friction wheel or via a belt, and wherein the first charging device includes the generator device.
